(19) United States
(12) Patent Application Publication
(10) Pub. No.: US 2020/0041751 A1
(43) Pub. Date: Feb. 6, 2020

(54) OPTICAL LENS AND OPTICAL CAMERA LENS

(71) Applicant: AAC Technologies Pte. Ltd., Singapore City (SG)

(72) Inventor: Hailong Wang, Shenzhen (CN)

(21) Appl. No.: 16/528,540

(22) Filed: Jul. 31, 2019

(30) Foreign Application Priority Data
Aug. 4, 2018 (CN) 201821252464.1

(51) Int. Cl. G02B 7/02

(52) U.S. Cl. CPC G02B 7/022; G02B 7/021

(57) ABSTRACT

The present disclosure relates to the field of optical imaging technologies, and provides an optical lens and an optical camera lens. The optical lens includes an optical portion located at a central position; and a peripheral portion surrounding the optical portion and including an object-side surface facing towards an object side, an image-side surface facing towards an image side, and a side surface connecting the object-side surface with the image-side surface. The side surface includes a circumferential surface extending along a circumferential direction surrounding the optical portion, and a lens facet connected to the circumferential surface. The peripheral portion is provided with a bearing portion. The bearing portion is close to the circumferential surface and spaced apart from the circumferential surface. The present disclosure further provides an optical camera lens including the optical lens.

### TECHNICAL FIELD

The present disclosure relates to the field of optical imaging technologies, and in particular, to an optical lens and an optical camera lens.

### BACKGROUND

With the continuous development of technology, electronic devices become more and more intelligent. In addition to digital cameras, portable electronic devices such as tablet PC and mobile phones are also equipped with lens modules having a photographing function in order to meet the users' requirements to take photos at any time. In the related art, a camera lens module includes a lens barrel and a plurality of optical lenses stacked in series and received in the lens barrel. Currently, a circular optical lens is generally used in the optical camera lens.

The inventors have found that the existing optical lens has at least the following problems. The circular optical lens occupies a large space and has a heavy weight, which is disadvantageous for the miniaturization design of the optical lens, and the optical lens is not convenient to carry. Therefore, it is necessary to provide a new lens module to solve the above problems.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a top view of an optical lens according to a first embodiment of the present disclosure;

FIG. 2 is a perspective schematic structural view of an optical lens according to a first embodiment of the present disclosure; and

FIG. 3 is a cross-sectional view of an optical camera lens according to a second embodiment of the present disclosure.

### DESCRIPTION OF EMBODIMENTS

The present disclosure will be further illustrated with reference to the accompanying drawings and the embodiments.

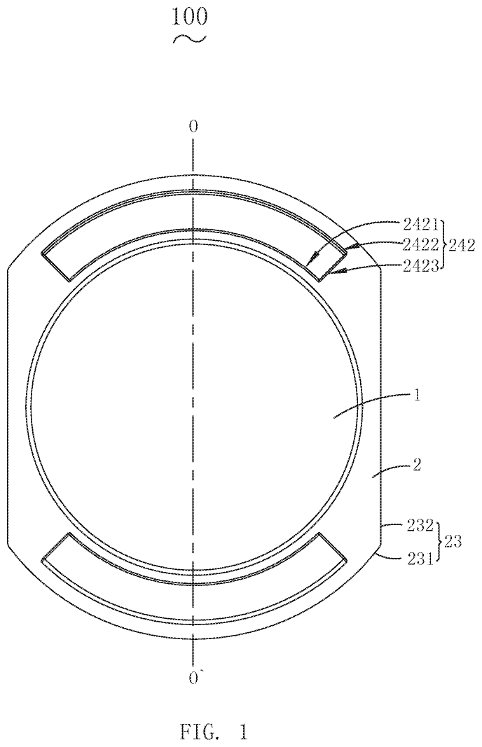

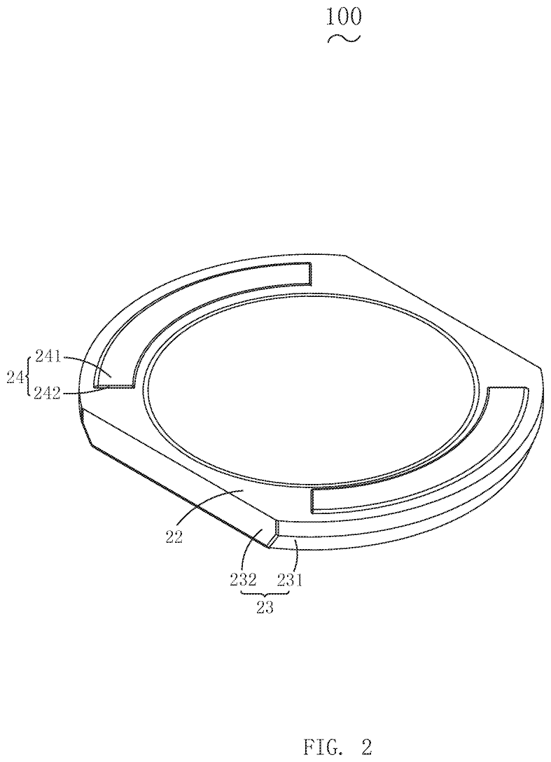

A first embodiment of the present disclosure provides an optical lens 100 as shown in FIGS. 1 and 2.

The optical lens 100 includes an optical portion 1 located at a central position, and a peripheral portion 2 surrounding the optical portion 1. The peripheral portion 2 includes an object-side surface 21 facing towards the object side, an image-side surface 22 facing towards the image side, and a side surface 23 connecting the object-side surface 21 with the image-side surface 22. The side surface 23 includes a circumferential surface 231 extending along a circumferential direction surrounding the optical portion 1, and a lens facet 232 connected to the circumferential surface 231. The peripheral portion 2 is provided with a bearing portion 24. The bearing portion 24 is close to the circumferential surface 231 and spaced apart from the circumferential surface 231.

Compared with the related art, in this embodiment, the side surface 23 includes the circumferential surface 231 extending in the circumferential direction surrounding the optical portion 1 and the lens facet 232 connected to the circumferential surface 231. The optical lens 100 with such a structure takes up a smaller space and is lighter in weight than the circle lens, thereby making the entire optical lens lighter and more portable. The peripheral portion 2 is provided with a bearing portion 24, which is close to the circumferential surface 231 and spaced apart from the circumferential surface 231. A contact area of two adjacent optical lenses 100 becomes smaller after the optical lens 100 is trimmed. By additionally providing the bearing portion 24 on the peripheral portion, the two adjacent optical lenses 100 can be abutted against each other by the bearing portion 24, thereby ensuring a high operability at the position of the lens facet 232 while ensuring the assembly stability of the optical lens 100 in the optical camera lens. In this way, the optical lens can be greatly trimmed to make the optical lens smaller.

In an example, the bearing portion 24 includes an end surface 241 facing away from the peripheral portion 2, and a sidewall 242 extending from the end surface 241 to the peripheral portion 2. The sidewall 242 includes a first surface 2421 close to the optical axis OO′, a second surface 2422 opposite to the first surface 2421, and a third surface 2423 connecting the first surface 2421 with the second surface 2422.

As an example, each of the first surface 2421 and the second surface 2422 is an arc surface around the optical axis OO′. Since the inner periphery and the outer periphery of the optical lens 100 are also circular, this arrangement increases the contact area between the bearing portion 24 and the peripheral portion 2, that is, the bearing portion 24 can be set to be larger. When two lenses abut against each other, the bearing portion 24 with a larger area can further improve the assembly stability of the optical lens 100.

It should be noted that in this embodiment, a plurality of receiving portions 24 is provided. The plurality of receiving portions 24 is equally spaced around the optical axis OO′. The bearing portions 24 are equally spaced, resulting in force equality when the two adjacent optical lenses 100 abut against each other, thereby improving the stability of the optical camera lens having such an optical lens 100.

It is worth mentioning that two lens facets 232 and two circumferential surfaces 231 are provided. The two lens facets 232 and the two circumferential surfaces 231 are alternately arranged around the optical axis OO′ of the optical lens 100.

In an example, the lens facet 100 is a planar surface.

It can be understood that the optical lens 100 is formed by cutting a circular optical lens, and a projection of the circular optical lens in the direction of the optical axis OO′ is circular. Two cutting lines are arranged on the basis of the original circular optical lens, and the optical lens can be obtained after cutting. It should be noted that in order to meet different requirements, a different number of cutting lines may be provided on the basis of the original circular optical lens, and the optical lens formed after cutting can achieve the same technical effect.

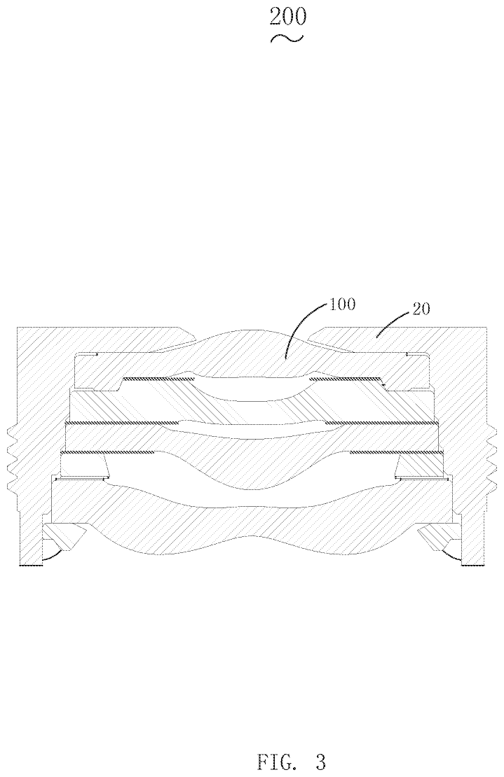

A second embodiment of the present disclosure provides an optical camera lens 200. As shown in FIG. 3, the optical camera lens 200 includes the optical lens 100 described above, and a lens barrel 20 receiving the optical lens 100.

The above are only preferred embodiments of the present disclosure. Here, it should be noted that those skilled in the art can make modifications without departing from the inventive concept of the present disclosure, but these shall fall into the protection scope of the present disclosure.

What is claimed is:

1. An optical lens, comprising:
an optical portion located at a central position; and
a peripheral portion surrounding the optical portion and comprising an object-side surface facing towards an object side, an image-side surface facing towards an image side, and a side surface connecting the object-side surface with the image-side surface,
wherein the side surface comprises a circumferential surface extending along a circumferential direction surrounding the optical portion, and a lens facet connected to the circumferential surface, the peripheral portion being provided with a bearing portion, and the bearing portion being close to the circumferential surface and spaced apart from the circumferential surface.

2. The optical lens as described in claim 1, wherein the bearing portion comprises an end surface facing away from the peripheral portion, and a side wall extending from the end surface to the peripheral portion, and
the side wall comprises a first surface close to an optical axis, a second surface opposite to the first surface, and a third surface connecting the first surface with the second surface.

3. The optical lens as described in claim 2, wherein each of the first surface and the second surface is an arc surface surrounding the optical axis.

4. The optical lens according as described in claim 3, wherein a plurality of the bearing portions is provided, and the plurality of the bearing portions is equally spaced around the optical axis.

5. The optical lens as described in claim 1, wherein two lens facets and two circumferential surfaces are provided, and the two lens facets and the two circumferential surfaces are alternately arranged around an optical axis of the optical lens.

6. The optical lens as described in claim 5, wherein the lens facet is a planar surface.

7. The optical lens as described in claim 1, wherein the optical lens is formed by cutting a circular optical lens, and a projection of the circular optical lens in a direction of an optical axis is circular.

8. An optical camera lens, comprising the optical lens as described in claim 1.

9. The optical camera lens as described in claim 8, wherein the bearing portion comprises an end surface facing away from the peripheral portion, and a side wall extending from the end surface to the peripheral portion, and
the side wall comprises a first surface close to an optical axis, a second surface opposite to the first surface, and a third surface connecting the first surface with the second surface.

10. The optical camera lens as described in claim 9, wherein each of the first surface and the second surface is an arc surface surrounding the optical axis.

11. The optical camera lens as described in claim 10, wherein a plurality of the bearing portions is provided, and the plurality of the bearing portions is equally spaced around the optical axis.

12. The optical camera lens as described in claim 8, wherein two lens facets and two circumferential surfaces are provided, and the two lens facets and the two circumferential surfaces are alternately arranged around an optical axis of the optical lens.

13. The optical camera lens as described in claim 12, wherein the lens facet is a planar surface.

14. The optical camera lens as described in claim 8, wherein the optical lens is formed by cutting a circular optical lens, and a projection of the circular optical lens in a direction of an optical axis is circular.
